(19) United States
(12) Patent Application Publication
(10) Pub. No.: US 2024/0407385 A1
(43) Pub. Date: Dec. 12, 2024

(54) HIGH PURITY PHYLLODULCIN EXTRACT

(71) Applicant: SYMRISE AG, Holzminden (DE)

(72) Inventors: Johannes KIEFL, Neustadt an der Aisch (DE); Margit LIEBIG, Stadtoldendorf (DE); Alexander KINDEL, Höxter (DE); Jakob Peter LEY, Holzminden (DE); Esther-Corinna SCHWARZE, Einbeck (DE)

(73) Assignee: SYMRISE AG, Holzminden (DE)

(21) Appl. No.: 18/700,542

(22) PCT Filed: Nov. 3, 2022
(86) PCT No.: PCT/EP2022/080719

§ 371 Date: Apr. 11, 2024

(30) Foreign Application Priority Data
Nov. 4, 2021 (WO) PCT/EP2021/080632

(51) Int. Cl. A23F 3/16; A23F 3/18; A23L 27/24

(52) U.S. Cl. CPC A23F 3/166; A23F 3/18; A23L 27/24

(57) ABSTRACT

The present invention relates to a method for producing a plant extract comprising phyllodulcin, a plant extract obtained or obtainable by such a method, a flavouring mixture comprising such a plant extract, a composition comprising such a plant extract, the use of such a plant extract or of such a flavouring mixture and a method for imparting or modifying a sweet taste impression.

The present invention relates to a method for producing a plant extract comprising phyllodulcin, a plant extract obtained or obtainable by such a method, a flavouring mixture comprising such a plant extract, a composition comprising such a plant extract, the use of such a plant extract or of such a flavouring mixture and a method for imparting or modifying a sweet taste impression.

Consumers generally have a strong preference for foodstuffs or indulgence foods, which have a large amount of high caloric sugar, in particular sucrose (saccharose), glucose, fructose or mixtures thereof, due to the pleasant sweetness and sweetness profile associated therewith. On the other hand, it is generally known that a large content of readily metabolizable carbohydrates causes a steep rise in blood sugar levels, leads to the formation of fat deposits and ultimately can result in health problems such as overweight, obesity, insulin resistance, age-onset diabetes and complications thereof. Another particular aggravating factor is that many of the above-mentioned carbohydrates can also have an adverse effect on dental health, as they are decomposed by specific types of bacteria in the oral cavity into lactic acid, for example, and can attack the enamel of milk teeth or adult teeth (caries).

Therefore, it has long been an objective to reduce the high caloric sugar content of food or beverage products and replace it partly or entirely by other substances that impart a sweet taste or which can positively affect the sweet taste in a low concentration without exhibiting sweet taste itself at these low concentration (taste modulators).

The use of phyllodulcin as taste modulator for sugar-reduced products, flavoring mixtures for same, and method of producing such products was described in EP 2,298,084-B1.

Phyllodulcin is a natural compound occurring in subspecies of the plant Hydrangea macrophylla. Phyllodulcin cannot be economically produced by chemical synthesis or biotechnological approaches.

The leaves of Hydrangea macrophylla are mainly used for preparing tea, particularly amacha, a sweet tasting Japanese tea, which contains tannins and dihydroisocoumarins including phyllodulcin. The leaves of Hydrangea macrophylla are typically used in Japan and Korea for ceremonial purposes (Buddhas birthday).

Several methods have been described for extracting phyllodulcin from the leaves of Hydrangea macrophylla. However, when used in products for nutrition or pleasure or in pharmaceutical products, several regulatory conditions need to be met. In this regard, the obtained extract must not contain detectable amounts of certain substances, such as chloroform, which are frequently used as solvents for extraction.

Furthermore, it is necessary that the sensory characteristics of phyllodulcin are not negatively affected by the extraction process or the compounds additionally present in the obtained extract. In this regard, it has been found that in an alkaline milieu phyllodulcin is converted to an open chain form and finally to a certain stilbene carboxylic acid, which has no considerable taste characteristics. Thus, when phyllodulcin is converted to degradation products, its sweetening characteristics are lost.

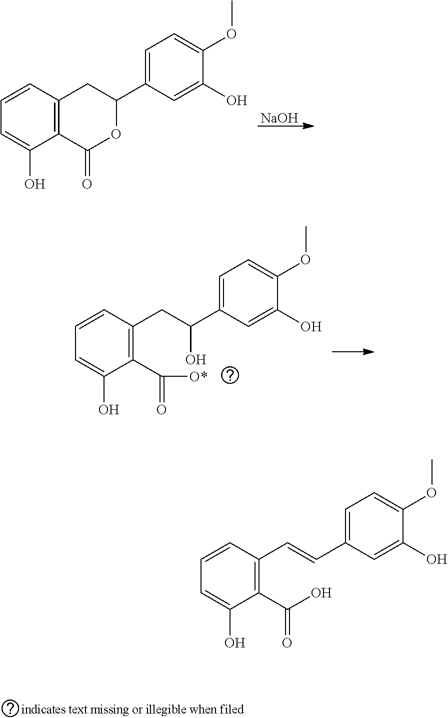

### Degradation of Phyllodulcin

JP51002480 describes a method, in which a tar-like precipitate is obtained by salting out phyllodulcin from an alcoholic extract. The precipitate was dissolved in methanol and an extraction with chloroform was performed. The product was obtained from the organic phase and finally recrystallized in methanol. However, due to regulatory reasons, chloroform must not be used for obtaining an extract, which is used in any consumed products. Furthermore, JP51002480 does not disclose the sensory purity of the obtained product.

Jung et al., Phytochem. Anal. 2016, 27, 140-147 discloses the extraction and isolation of phyllodulcin from the leaves of Hydrangea macrophylla for analytical purposes. The method is performed by applying steps comprising ultrasound and high pressure extraction combined with preparative HPLC. However, for the industrial purposes of obtaining extracts with a high amount of phyllodulcin, this method is not suitable, as the above steps are not relevant due to economical reasons.

KR101662498 discloses a method, in which the leaves are wet fermented and subsequently extracted with methanol or ethanol. The obtained extract is purified by ion exchange and a reverse-phase solid phase and elution with acetonitrile. Finally, the product is obtained by chromatographic separation by HPLC. However, the method applies 5 steps of separation and is thus not suitable for industrial purposes. Furthermore, expensive materials such as the reverse-phase solid phase are used. Moreover, acetonitrile must not be used for obtaining an extract, which is used in any consumed products, for regulatory reasons.

KR 20210074526A discloses a method for extracting phyllodulcin, however, the possibility of reducing off-tastes, which are frequently observed, is not addressed.

Kim Min-Ji et al.: “Relative sweetness and sweetness quality of phyllodulcin [(3R)-8-Hydroxy-3-(3-hydroxy-4-methoxyphenyl)-3,4-dihydro-1 H-isochromen-1-one]”, Food Science And Biotechnology, The Korea Soc. Of Food Science And Technology, Heidelberg, vol. 25, no. 4, 31 Aug. 2016 discloses plant extracts comprising phyllodulcin. However, the plant extracts are described as having strong bitter notes, alcohol notes and as being rather astringent.

JPS5724745 describes the extraction of phyllodulcin with mixtures of water and alcohols. Subsequently, the alkali salt is obtained and precipitated and the product is washed with chloroform. As described above, chloroform must not be used for regulatory reasons. Furthermore, when obtaining the alkali salt, phyllodulcin is converted to the respective stilbene carboxylic acid, thus losing the sweetening characteristics of phyllodulcin.

EP 2298084 describes the production of extracts containing phyllodulcin, wherein the extracts contain 14% phyllodulcin when the extraction is performed with ethyl acetate or contain 5.3% or, respectively, 3.2% phyllodulcin when a hydroalcoholic extraction is performed. However, the amounts or phyllodulcin are rather low. Furthermore, it is described that the extracts have a herbaceous, fishy, liquorice-like, tea-like, woody and slightly bitter olfactory and gustatory notes. Consequently, the obtained extracts and the method of their production are not suitable for providing a flavouring mixture.

Therefore, a great need exists to provide methods for producing an extract containing phyllodulcin, wherein the extract can be used for products for nutrition or pleasure or for pharmaceutical products and wherein the sensory characteristics of phyllodulcin can be used.

The primary object of the present invention was thus to provide a method for producing an extract containing a possibly high amount of phyllodulcin, wherein the extract can be used for products for nutrition or pleasure or for pharmaceutical products and wherein the sensory characteristics of phyllodulcin can be used. Furthermore and preferably, the extract should not have any off-notes such as a herbaceous, fishy, liquorice-like, tea-like, woody and slightly bitter olfactory and gustatory notes and/or the extract should be stable when stored.

The primary object of the present invention is solved by a method for producing a plant extract comprising phyllodulcin, wherein the method comprises or consists of the following steps:
i) Drying the plant material to be extracted, preferably wherein the plant material predominantly consists of plant leaves, preferably wherein the plant material is of a plant of the species Hydrangea macrophylla preferably of the subspecies serrata, more preferably selected from the group consisting of the varieties oamacha, amacha and amagi-amacha,
ii) moistening the dried plant material of step i) with water and wet fermenting the plant material at a temperature in the range of from 10 to 50° C., preferably in the range of from 30 to 45° C., for 0.5 to 72 hours, preferably for 0.5 to 16 hours, particularly preferably for 1 to 5 hours,
iii) subjecting the wet fermented plant material of step ii) to an extraction with a solvent, at a temperature of from 0° C. to the boiling point of the respective solvent,
preferably wherein the solvent is selected from the group consisting of water, sub-critical or supercritical water, supercritical CO₂, methanol, methyl acetate, ethanol, ethyl acetate, n-heptane, n-hexane, deep eutectic solvents and mixtures thereof,
particularly preferably, wherein the solvent is ethyl acetate or ethanol,
iv) collecting the supernatant (S1) of the extraction of step iii) and optionally:
   repeating step iii), collecting the supernatant (S2) and combining supernatants S1 and S2,
v) replacing the solvent in the supernatant or combined supernatant of step iv) with ethanol, wherein this step is optional in case ethanol or a mixture comprising ethanol was used as a solvent in step iii) and/or step iv),
vi) heating the mixture obtained in step v), or step iv) in case step v) is not present, to a temperature in the range of from 40 to 79° C. to reduce the amount of ethanol,
vii) cooling the mixture of step vi) to a temperature of 10° C. or less for precipitating the extracted compound(s),
viii) washing the mixture of step vii) with a washing agent, preferably ethanol,
wherein the washing agent has a temperature of 10° C. or less and
wherein the ratio of the weight of the washing agent and the weight of the mixture of step vii) is at least 1:1, preferably at least 2.5:1, particularly preferably at least 5:1,
ix) drying the precipitated extracted compounds to obtain an extract comprising phyllodulcin.

It was surprisingly found that with a method according to the present invention, a high content of phyllodulcin was yielded. Simultaneously, the extracts have no or no considerable off-notes, which was only obtained by a method according to the invention. In contrast, the extracts of a comparative method had several off-notes as also shown in the examples below.

Furthermore, it was surprisingly found that an extract obtained by a method according to the invention is particularly stable when being stored.

The term “drying” as used herein, preferably as used in step i) and/or step ix) of the method according to the invention describes a process, in which the water content of the material or mixture to a residual water content of less than 5 wt.-%, preferably less than 2.5 wt.-%, particularly preferably less than 1 wt.-%, based on the total weight of the material or mixture. Preferably, the step of drying in step i) of the method according to the invention is performed by a method selected from the group consisting of heat drying, sun drying, hot air drying, combined air and heat pump drying, vacuum oven drying, freeze drying and/or in step ix) of the method according to the invention is performed by a method selected from the group consisting of heat drying, vacuum oven drying, freeze drying, spray drying, and (vacuum) belt drying.

Preferably, the water content is determined by dry-loss-method or Karl-Fischer titration.

It is preferred that the dry matter content of the material or mixture, i.e. the portion, which is not water, is at least 95 wt.-% preferably at least 97.5 wt.-%, particularly preferably at least 99 wt.-%, based on the total weight of the material or mixture.

The term “wherein the plant material predominantly consists of” as used herein refers to an amount of at least 90 wt.-%, preferably at least 95 wt.-%, particularly preferably at least 98 wt.-%, especially preferably at least 99 wt.-%, based on the total weight of the plant material.

The plant varieties amacha and amagi-amacha, as mentioned herein as plant varieties of Hydrangea macrophylla, are also known as varieties thunbergii or, respectively, amagiana.

It is preferred in the method according to the invention that the method includes a step ii.2), which is performed between step ii) and step iii) and which includes removing fermentation water, wherein the removal is achieved by e.g. applying mechanical or air pressure filtration, decantation, centrifugation, combined filtration and centrifugation, hot air drying, combined air and heat pump drying, vacuum oven drying, or freeze drying. Preferably, removing fermentation water describes removing at least 50 wt.-%, preferably at least 75 wt.-%, particularly preferably at least 90 wt.-%, further preferably at least 95 wt.-% of the fermentation water, based on the mixture of the plant material and water as obtained in step ii) of the method according to the invention.

The term “boiling point” as used herein describes the boiling point at standard conditions, i.e. a pressure of 1013 mbar. In case it is referred to the boiling point of a mixture of substances, the skilled person knows that the boiling points of the respective single substances are known in literature and a boiling point can be calculated accordingly for the mixture. In this case, the term “boiling point” describes the calculated boiling point.

It is preferred that step iii) of the method according to the invention is performed at normal pressure, i.e. a pressure of 1013 mbar. Alternatively, step iii) is performed at reduced pressure. Alternatively, step iii) is performed at elevated pressure.

It is further preferred that the extraction in step iii) of the method according to the invention is performed by a method selected from the group consisting of Soxhlet, counter-current, percolation and maceration.

Deep eutectic solvents are mixtures of at least two components where the mixture shows a melting point much lower than either of the individual components. Preferably natural components such as sugars, alcohols, amines, organic acids or amino acids are used as such solvents.

Moreover, the term “deep eutectic solvents” as described herein describes solvents including natural deep eutectic solvents and further deep eutectic solvents. Preferably, the term “deep eutectic solvents” as described herein describes natural deep eutectic solvents as described in Gullón, P., et al. (2020). “Smart advanced solvents for bioactive compounds recovery from agri-food by-products: A review.” Trends in Food Science & Technology 101: 182-197 and Benvenutti, L., et al. (2019). “Which is the best food emerging solvent: IL, DES or NADES?” Trends in Food Science & Technology.

As described above for step iv), step iii) of the method according to the present invention may (optionally) be repeated. Preferably, step iii) is repeated twice or three times, i.e. step iv) is performed three times or four times. Preferably, in case step iii) is repeated, the same type of solvent is used each time step iii) is performed, i.e. in case step iii) is performed a first time with water as solvent, it is preferred that in each repetition, water is used as a solvent. Additionally or alternatively, the time of extraction in step iii), in a method, in which step iii) is repeated, may be shorter or longer than in a method, in which step iii) is not repeated. For example, one method according to the invention may comprise an extraction for 2 hours, wherein step iii) is repeated twice (i.e. step iii) is performed three times), whereas another method according to the invention may comprise an extraction for 4 hours, wherein step iii) is not repeated (i.e. step iii) is performed once).

Step v) of the method according to the present invention describes a step of replacing the solvent with ethanol. In case the solvent is a mixture of ethanol and another solvent, the term “replacing” may preferably be understood as removing the other solvent such that at least 85 wt. % ethanol, preferably at least 90 wt.-% ethanol, particularly preferably at least 95 wt.-% ethanol, further preferably at least 97 wt.-% ethanol, even further preferably at least 98 wt.-%, more preferably at least 99 wt.-% ethanol, based on the total weight of ethanol and the other solvent, or only ethanol remains as solvent. In this preferred understanding, no additional ethanol needs to be added, i.e. the addition is optional.

It is also preferred that the term “heating”, as used e.g. in step vi) of the method according to the invention, includes “maintaining” the temperature, in case the temperature is already at the intended value.

Preferably, the cooling step in step vii) of the method according to the invention is performed by gradually cooling to a temperature in the range of from 0 to 10° C. at a rate of 1 to 20° C. per hour, preferably followed by a time in the range of from 1 to 72 hours of incubation at the final temperature, preferably with continuous agitation. Preferably, the cooling step in step vii) of the method according to the invention is performed by gradually cooling at a rate of 10° C. per hour and incubated for 1 day to facilitate the crystallization of phyllodulcin.

It has been surprisingly found that by the precipitation it was possible to significantly reduce the amount of hydrangenol in the obtained extract. Furthermore, particularly high amounts of phyllodulcin were obtained.

It is preferred in the method according to the invention that the extract is purified by solid-phase adsorption after the extraction in step iii) and/or repeated step iii) according to step iv) and preferably before step iv) is performed.

Additionally in the above case, it is also preferred that the adsorbent used in the solid-phase adsorption is selected from the group consisting of polystyrene, aliphatic methyl acrylate and mixtures thereof,
preferably wherein the adsorbent is polystyrene or a mixture of polystyrene and aliphatic methyl acrylate and wherein the polystyrene is cross-linked, preferably with a divinyl benzene,
particularly preferably wherein the adsorbent is polystyrene or a mixture of polystyrene and aliphatic methyl acrylate and wherein the polystyrene is cross-linked, preferably with a divinyl benzene, and wherein the polystyrene is macroporous and/or wherein the aliphatic methyl acrylate is microporous.

The term “macroporous” as used herein describes a material with pores having an average pore size of more than 2 nm, preferably a pore size of from 5 to 110 nm. The average pore size is the measured or calculated average over the size of all pores in the material. Methods for determining the pore size are well-known and include e.g. the Hg intrusion method.

The term “microporous” as used herein describes a material with pores having an average pore size of equal or less than 2 nm. The average pore size is the measured or calculated average over the size of all pores in the material. Methods for determining the pore size are well-known and include e.g. the Hg intrusion method.

Preferably, the term “a divinyl benzene” describes a divinyl benzene selected from the group consisting of 1,2-Divinylbenzol, 1,3-Divinylbenzol, 1,4-Divinylbenzol and mixtures thereof.

It is further preferred in the method according to the invention that the extraction in step iii) is performed over a time in the range of from 0.5 to 10 hours, preferably 0.75 to 5 hours, particularly preferably from 1 to 3 hours.

Preferably in the method according to the invention, in step v) the replacement is achieved by distillation or a method including distillation. In case the solvent to be replaced has a similar or higher boiling point than the replacing solvent, i.e. ethanol, the replacement is achieved by e.g. membrane filtration. However, preferably, the solvent to be replaced has a lower boiling point than the replacing solvent, i.e. ethanol.

It is also preferred in the method according to the invention that after step vi), the mixture is filtered, preferably before the mixture is cooled in step vii). Preferably the mixture is hot filtered. Further preferably, a filter with a mesh size of at least/at most 5 μm is used.

Preferably in the method according to the invention, the plant material comprises at least 2.5 wt.-%, preferably at least 3 wt.-%, particularly preferably at least 4 wt.-%, especially preferably at least 5 wt.-%, phyllodulcin or phyllodulcin equivalents, based on the total weight of the plant material.

Generally, the term “phyllodulcin” describes a chemical compound, which is classified as aglycon. However, in nature, phyllodulcin is often present in form of a glycoside, wherein several glycosides are known in the prior art and to a skilled person. The term “phyllodulcin equivalents” as used herein describes the aglycon as well as the phyllodulcin glycosides. Thus, if an amount of phyllodulcin equivalents is to be determined, both the aglycon as well as the phyllodulcin glycosides are to be considered, each as far as present, but preferably calculated on the base of virtually free phyllodulcin by deglycosidation. Furthermore, it is preferred in a method according to the present invention that, after the fermentation according to step ii), phyllodulcin is substantially present in its aglycon form.

Typical glycosides of phyllodulcin, included in the term “phyllodulcin glycosides” are for example but not limited to:

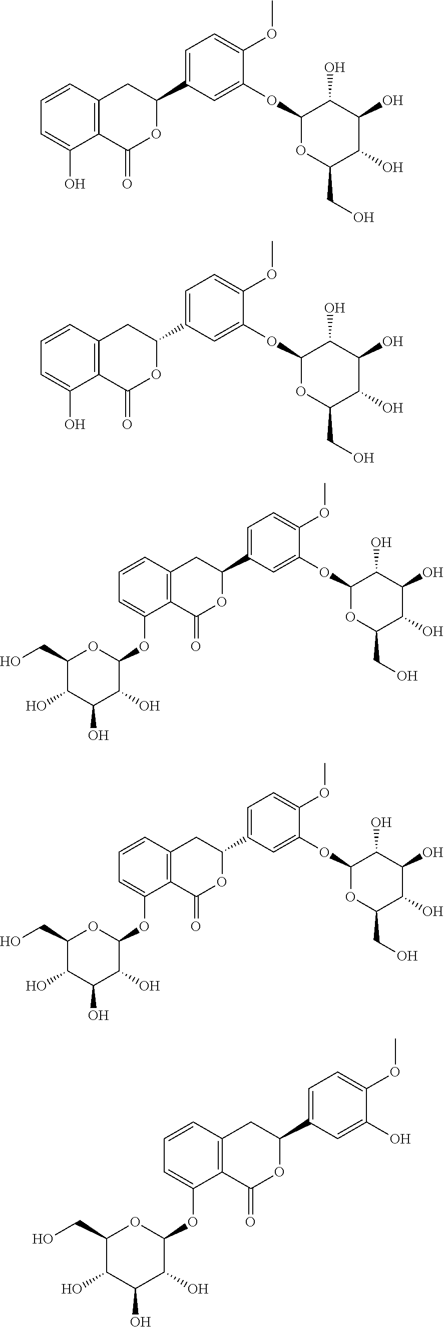

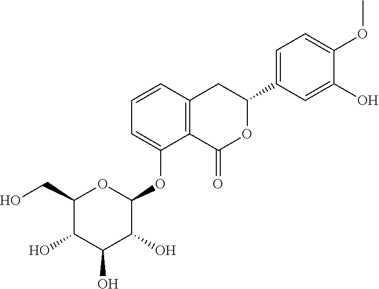 [SMILES: COc1ccc([C@H]2Cc3cccc(O[C@@H]4O[C@H](CO)[C@@H](O)[C@H](O)[C@H]4O)c3C(=O)O2)cc1O]

Preferably, the term “phyllodulcin” describes a mixture of phyllodulcin enantiomers (and their glycosides), wherein the amount of the enantiomer (3R)-phyllodulcin is higher than each of the amounts of the other enantiomers, particularly preferably higher than the combined amounts of the other enantiomers.

Also preferred in the method according to the invention is that the plant material comprises 2 wt.-% or less, preferably 1.5 wt.-% or less, particularly preferably 1.0 wt.-% or less, especially preferably 0.5 wt.-% or less, hydrangenol or hydrangenol equivalents, based on the total weight of the plant material.

It is further preferred in the method according to the invention that the weight ratio of phyllodulcin and hydrangenol in the plant material is in a range of from 1:1 to 1:50, preferably in a range of from 1:2 to 1:40, preferably in a range of from 1:3 to 1:30, preferably in a range of from 1:4 to 1:25, preferably in a range of from 1:5 to 1:20.

Generally, the term “hydrangenol” describes a chemical compound, which is classified as aglycon. However, in nature, hydrangenol is often present in form of a glycoside, wherein several glycosides are known in the prior art and to a skilled person. In addition, hydrangenol can also be present as open chain version, so called hydrangeic acid or its glycosides. The term “hydrangenol equivalents” as used herein describes the aglycon as well as the hydrangenol glycosides and preferably also hydrangeic acid as well as its glycosides. Thus, if an amount of hydrangenol equivalents is to be determined, both the aglycon as well as the hydrangenol glycosides are to be considered, preferably also the aglycon as well as the glycosides of hydrangeic acid, each as far as present, but calculated on the base of virtually free hydrangenol by deglycosidation. Furthermore, it is preferred in a method according to the present invention that, after the fermentation according to step ii), hydrangenol and/or hydrangeic acid is/are substantially present in its/their (respective) aglycon form.

Typical glycosides of hydrangenol, included in the term “hydrangenol glycosides” are for example but not limited to:

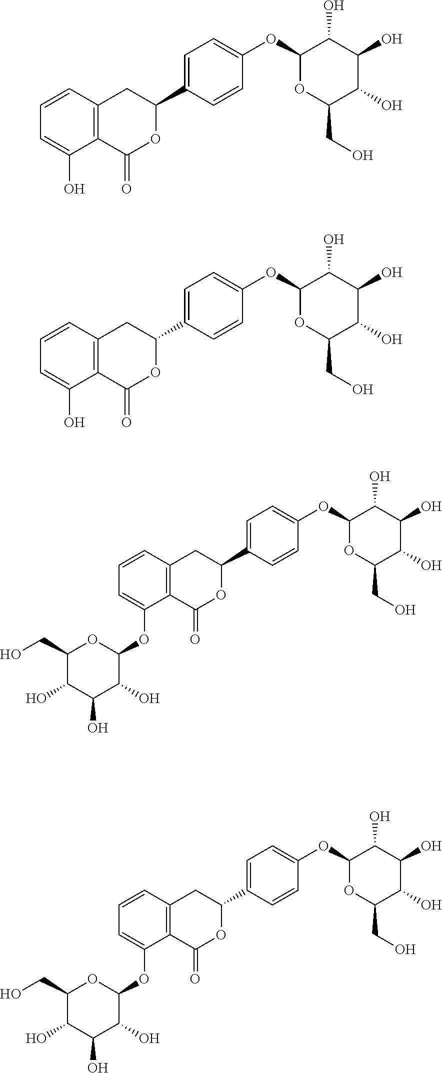 [SMILES: O=C1O[C@H](c2ccc(O[C@@H]3O[C@H](CO)[C@@H](O)[C@H](O)[C@H]3O)cc2)Cc2cccc(O)c21 ; O=C1O[C@@H](c2ccc(O[C@@H]3O[C@H](CO)[C@@H](O)[C@H](O)[C@H]3O)cc2)Cc2cccc(O)c21 ; O=C1O[C@H](c2ccc(O[C@@H]3O[C@H](CO)[C@@H](O)[C@H](O)[C@H]3O)cc2)Cc2cccc(O[C@@H]3O[C@H](CO)[C@@H](O)[C@H](O)[C@H]3O)c21 ; O=C1O[C@@H](c2ccc(O[C@@H]3O[C@H](CO)[C@@H](O)[C@H](O)[C@H]3O)cc2)Cc2cccc(O[C@@H]3O[C@H](CO)[C@@H](O)[C@H](O)[C@H]3O)c21]

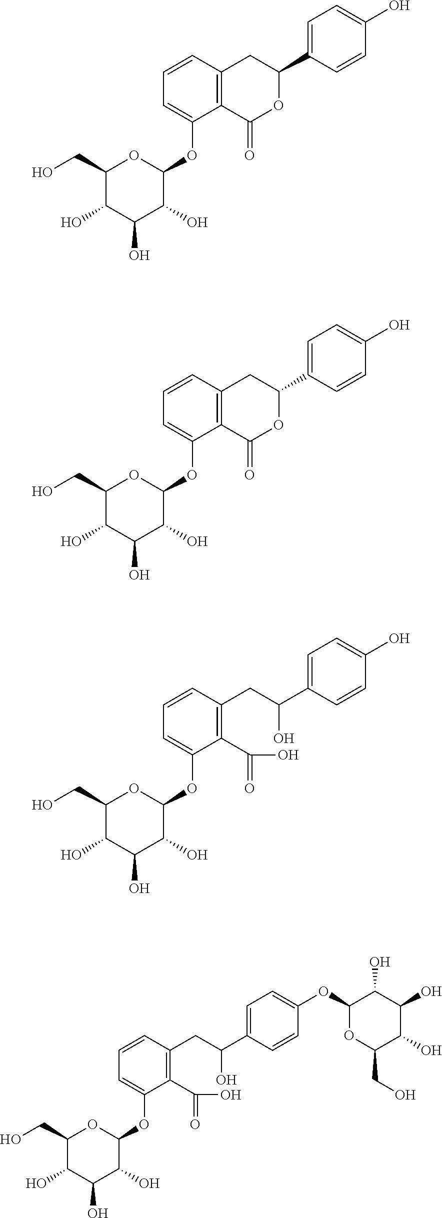 [SMILES: O=C1O[C@H](c2ccc(O)cc2)Cc2cccc(O[C@@H]3O[C@H](CO)[C@@H](O)[C@H](O)[C@H]3O)c21 ; O=C1O[C@@H](c2ccc(O)cc2)Cc2cccc(O[C@@H]3O[C@H](CO)[C@@H](O)[C@H](O)[C@H]3O)c21 ; O=C(O)c1c(CC(O)c2ccc(O)cc2)cccc1O[C@@H]1O[C@H](CO)[C@@H](O)[C@H](O)[C@H]1O ; O=C(O)c1c(CC(O)c2ccc(O[C@@H]3O[C@H](CO)[C@@H](O)[C@H](O)[C@H]3O)cc2)cccc1O[C@@H]1O[C@H](CO)[C@@H](O)[C@H](O)[C@H]1O]

The present invention further relates to a plant extract obtained or obtainable by a method according to the invention,
wherein the extract comprises at least 50 wt.-%, preferably at least 60 wt.-% particularly preferably at least 65 wt.-%, especially preferably at least 70 wt.-% phyllodulcin, based on the total weight of the dry matter content of the extract,
and/or
wherein the extract comprises less than 20 wt.-%, preferably less than 15 wt.-%, particularly preferably less than 10 wt.-%, especially preferably less than 5 wt.-% hydrangenol, based on the total weight of the dry matter content of the extract.

The term “plant extract comprising at least 50 wt.-% phyllodulcin” as used herein is understood as excluding phyllodulcin as a pure substance, i.e. 100 wt.-% phyllodulcin. The term “plant extract” clarifies in this regard that phyllodulcin is obtained, i.e. extracted, from a plant source and is not the result of a chemical synthesis producing phyllodulcin from a precursor. The same applies accordingly for the further specified wt.-% indications as well as for the term “plant extract comprising less than 20 wt.-% hydrangenol” and the further specified wt.-% indications in this regard.

The term “dry matter content of the extract” describes the portion of the extract according to the invention, which is not water, i.e. excludes the water content. Preferably, the dry matter content of the extract is at least 95 wt.-% preferably at least 97.5 wt.-%, particularly preferably at least 99 wt.-%, based on the total weight of the extract.

Preferably, the extract according to the invention comprises at least 0.05 wt.-%, preferably at least 0.1 wt.-%, particularly preferably at least 0.5 wt.-%, more preferably at least 1 wt.-%, further preferably at least 5 wt.-%, most preferably at least 10 wt.-% of plant based components, based on the total weight of the extract.

Additionally or alternatively it is preferred that the extract according to the invention comprises at most 30 wt.-%, preferably at most 25 wt.-%, particularly preferably at most 20 wt.-%, more preferably at most 10 wt.-%, further preferably at most 5 wt.-%, most preferably at most 1 wt.-% of plant based components, based on the total weight of the extract.

The term “plant based components” describes components, which are present in the plant material, from which the extract was obtained, but excludes phyllodulcin and hydrangenol (and their glycosides, as described above). Preferably, the term “plant based components” describes components selected from the group consisting of chlorophyll, rubisco, other proteins, triacylglyceride, waxes, cellulose, sugars, amino acids, flavonoids, hydroxybenzoic acids, and further aroma compounds.

Preferably, the extract according to the invention comprises phyllodulcin in an amount of from 75 to 95 wt.-%, preferably 77.5 to 90 wt.-%, based on the total weight of the dry matter content of the extract.

It has been surprisingly found that an extract according to the invention comprising phyllodulcin in an amount of from 75 to 95 wt.-%, based on the total weight of the dry matter content of the extract, provides the same sweetness as the pure substance (R)-phyllodulcin (see Example 4 below), whereas other extracts according to the invention comprising more or less phyllodulcin provided a slightly weaker sweetness than the pure substance (R)-phyllodulcin.

Preferably, the extract according to the invention comprises hydrangenol in an amount of from 15 to 25 wt.-%, preferably less than 20 wt.-%, preferably less than 15 wt.-%, particularly preferably less than 10 wt.-%, especially preferably less than 5 wt.-% hydrangenol, each based on the total weight of the dry matter content of the extract.

Preferably, the extract according to the invention comprises hydrangenol in an amount of from 0.1 to 7.5 wt.-%, preferably in an amount of from 0.5 to 6 wt.-%, preferably in an amount of from 1 to 5 wt.-%, based on the total weight of the dry matter content of the extract.

It is preferred that in the plant extract according to the invention the weight ratio of phyllodulcin and hydrangenol is at least 3:1, preferably at least 5:1, particularly preferably at least 7:1, further preferably at least 10:1, more preferably at least 15:1, most preferably at least 25:1, even further preferably at least 30:1, preferably at least 35:1, preferably at least 40:1, preferably at least 45:1, preferably at least 50:1, preferably at least 55:1, preferably at least 60:1, preferably at least 65:1, preferably at least 70:1.

The invention further relates to a flavouring mixture comprising a plant extract according to the invention, preferably wherein the flavouring mixture comprises at least 1 wt.-%, preferably at least 3 wt.-% particularly preferably at least 5 wt.-%, especially preferably at least 10 wt.-% phyllodulcin, based on the total weight of the flavouring mixture and/or preferably wherein the flavouring mixture comprises less than 5 wt.-%, preferably less than 1 wt.-%, particularly preferably less than 0.5 wt.-%, especially preferably less than 0.1 wt.-% hydrangenol, based on the total weight of the flavouring mixture.

Preferably, the flavouring mixture according to the invention differs from a plant extract according to the invention by that the flavouring mixture comprises one or more additional substance(s), which are not obtained via an extraction of plant material to produce the plant extract according to the invention. Additionally or alternatively, the plant extract may comprise one or more substances providing or enhancing an undesired olfactory or gustatory taste impression or modifying such an impression in an undesired way, according to which the plant extract is not suitable as flavouring mixture. In this case, the flavouring mixture may comprise such a plant extract, however, wherein this/these substance(s) were removed or reduced or wherein the undesired impression caused by this/these substance(s) is masked, reduced or modified by one or more further substances.

It is further preferred that the flavouring mixture according to the invention comprises at least one further compound or compound mixture conveying a sweet taste, preferably selected from the group consisting of
natural sweeteners, preferably naturally occurring sweet tasting substances, including plant extracts, such as sweet tasting carbohydrates (such as sucrose, trehalose, lactose, maltose, melizitose, melibiose, raffinose, palatinose, lactulose, D-fructose, D-glucose, D-galactose, I-rhamnose, D-sorbose, D-mannose, D-tagatose, D-arabinose, I-arabinose, D-ribose, D-glyceraldehyde, maltodextrin), sugar alcohols (such as erythritol, threitol, arabitol, ribitol, xylitol, sorbitol, mannitol, maltitol, isomaltit, dulcitol, lactitol), proteins (such as miraculin, pentaidin, monellin, thaumatin, curculin, brazzein, mabinlin), D-amino acids (such as D-phenylalanine, D-tryptophan) or extracts or fractions obtained from natural sources containing these amino acids and/or proteins and the physiologically acceptable salts of these amino acids and/or proteins, particularly the sodium, potassium, calcium or ammonium salts thereof; neohesperidin dihydrochalkone, naringin dihydrochalkone, steviolgylcoside, stevioside, steviolbiosid, rebaudioside, rebaudioside A, rebaudioside B, rebaudioside C, rebaudioside D, rebaudioside E, rebaudioside F, rebaudioside G, rebaudioside H, rebaudioside M, rebaudioside N, rebaudioside X, dulcoside, rubusoside, suavioside A, suavioside B, suavioside G, suavioside H, suavioside I, suavioside J, baiyunoside 1, baiyunoside 2, phlomisoside 1, phlomisoside 2, phlomisoside 3, phlomisoside 4, abrusoside A, abrusoside B, abrusoside C, abrusoside D, cyclocaryoside A, cyclocaryoside I, oslandin, polypodoside A, strogin 1, strogin, 2, strogin 4, selligueanin A, dihydroquercetin-3-acetate, perillartin, telosmosid A15, periandrin I-V, pterocaryoside, cyclocaryoside, mukurozioside, trans-Anethol, trans-cinnamaldehyd, bryoside, bryonoside, bryonodulcoside, carnosifloside, scandenoside, gypenoside, hematoxylin, cyanin, chlorogensäure, albiziasaponin, telosmoside, gaudichaudiosid, mogrosides, such as mogroside V, hernandulcine, monatin, glycyrrhetinic acid and its derivatives, particularly glycyrrhizin, preferably glycyrrhizin ammonium salt; extracts or enriched fractions of such extracts such as extracts of thaumatococcus or stevia ssp., particularly stevia rebaudiana, swingle extracts, particularly momordica or siratio grosvenorii or Luo-Han-Guo, extracts of glycerrhyzia ssp., particularly glycerrhyzia glabra, extracts of rubus ssp., particularly rubus suavissimus, extracts of lippia dulcis, extracts of mycetia balansae, preferably comprising balansin A and/or balansin B;
synthetic sweeteners, preferably synthetic sweet tasting substances, preferably selected from the group consisting of magap, sodium cyclamate or other physiologically acceptable salts of cyclamic acid, acesulfam K, neohesperidin dihydrochalcone, naringin dihydrochalcone, saccharin, saccharin sodium salt, aspartame, superaspartame, neotame, alitame, advantame, perillartin, sucralose, lugduname, carrelame, sucrononate or sucrooctate or mixtures thereof.

Additionally or alternatively, the flavouring mixture may comprise at least one additional flavouring selected from the group consisting of
aliphatic flavouring substances, especially saturated aliphatic alcohols, such as ethanol, isopronanol, butanol, isoamyl alcohol, hexanol, 2-heptanol, octanol (1/2/3), decanol, unsaturated aliphatic alcohols, such as cis-2 pentenol, cis-3 hexenol, trans-2 hexenol, trans-3 hexenol, cis-2 octenol, 1-octen-3-ol, cis-6 nonen-1-ol, trans-2, cis-6 nonadienol, aliphatic aldehydes such as saturated aliphatic aldehydes (e.g. acetaldehyde, propionaldehyde, butyraldehyde, isobutyraldehyde, valeraldehyde, isolvaleraldehyde, hexanal, 3-methyl hexanal, octanal, nonanal, or mono- or multi-unsaturated aliphatic aldehydes, such as 2-methyl but-2-enal, trans-2 hexenal, cis-3 hexenal, cis-4 hexenal, trans-2 octenal, trans-2 nonenal, cis-6 nonenal, trans-2, cis-6 nonadienal, trans 2 decenal, trans-2, trans-decadienal, aliphatic ketones, e.g. saturated ketones (such as 2-butanone, 2-pentanone, 2-heptanone, 2-octanone, 2-methylheptan-3-one, 2-decanone, 2-undecanone), unsaturated ketones (such as 1-penten-3-one, 1-hexen-3-one, 5-methyl-3-hexenone, 3-hepten-2-one, 1-octen-3-one, 2-octen-4-one, 3-octen-2-one, 3-none-2-one), aliphatic diketones and aliphatic diketoles, e.g. diacetyl, acetyl methyl carbinol, 2,3-hexanedione, aliphatic acids, such as straight-chain saturated acids, such as acetic acid, propionic acid, butyric acid, isobutyric acid, valeric acid, heptanoic acid, octanoic acid, decanoic acid, branched-chain saturated acids, such as 2-methyl heptanoic acid, 4-ethyl octanoic acid, and unsaturated acids, such as 2-butenoic acid, 2-pentenoic acid, 4-pentenoic acid, 2-methyl pentenoic acid, trans-3 hexenoic acid, cis-3 hexenoic acid, 3-octenoic acid, linoleic acid), aliphatic esters, such as saturated esters, e.g. methyl acetate, methylbutyrate, methyl-2-methylbutyrate, methyl hexanoate, ethylacetate, ethylbutyrate, ethyl-2-methylbutyrate, ethyl-3-methylbutyrate, ethyl hexanoate, ethyl decanoate, isopropyl acetate, isobutyl acetate, isobutyl valerate, isoamyl acetate, isoamyl butyrate, isoamyl isovalerate, hexyl acetate, hexyl hexanoate, 3-octyl acetate and unsaturated esters, such as methyl 2-hexenoate, allyl hexanoate, cis-3 hexenyl acetate, cis-3 hexenyl butyrate, aliphatic thiols and dithiols (e.g. propane thiol, allyl mercaptan, 1-methoxy-3-methylbutane-3-thiol, dimethyl sulfide, dimethyl trisulfide, dipropyl sulfide, diallyl trisulfide, other aliphatic sulfur compounds, such as 2-mercapto-3-butanol, methyl thio propanal, 3-mercapto-pentanone, 4-methoxy-2-methyl-2-mercaptobutanone, methyl thiobutyrate, methyl thiobutyrate, methyl 3-methylthio-propionate, aliphatic nitrogen compounds, such as butyl amine, trimethyl amine, allyl isothiocyanate, isopropyl isothiocyanate, alicyclic compounds, such as alicyclic ketones, e.g. cis-jasmone, isophorone, 4-ketoisophorone, alicyclic esters such as methyl jasmonate, hedione, terpenes, e.g. terpene alcohols, such as linalool, citronellol, geraniol, nerol, alpha terpineol, menthol, 8-p-menthene-1,2-diol, fenchol, borneol, nerolidol, hotrienol, terpene aldehydes such as geranial, neral, citronellal, beta-sinensal, terpene ketones, such as alpha-ionone, (D)-carvone, (L)-carvone, nootkatone, piperitone, menthone, alpha damascone, beta damascene, damascenone, terpene esters, such as linalyl acetate, geranyl acetate, citronellyl actetate, carvyl acetate, fenchyl acetate, terpene sulphur compounds, 4-mentha-8-thiol-3-one, thiogeraniol, para-menth-1-ene-8-thiol, mercapto p-menthan-3-one, terpene hydrocarbons, such as D-limonene, L-limonene, alpha-pinene, beta-pinene, ocimene, alpha-terpinene, gamma-terpinene, beta-bisabolene, valencene, terpene oxides, such as 1,8-cineole, rose oxide, mint lactone, menthofuran, aromatic compounds, e.g. aromatic alcohols, such as benzyl alcohol, cinnamyl alcohol, 2-phenyl alcohol, aromatic aldehydes, such as benzaldehyde, cinnamic aldehyde, 5-methyl-2-phenylhexenal, salicylaldehyde, 4-hydroxy benzaldehyde, cyclamen aldehyde, 2-phenyl-2-butenal, aromatic acids, such as 2-phenyl acetic acid, cinnamic acid, aromatic esters such as benzyl acetate, benzyl salicylate, anisyl acetate, methyl phenyl acetate, methyl benzoate, methyl salicylate, methyl cinnamate, aromatic phenols, such as phenol, ortho-cresol, para-cresol, 2,3-dimethyl phenyl, 2-ethyl phenol, 2,3,5-trimethyl phenol, 4-vinyl phenol, guaiacol, 4-vinyl guaiacol, eugenol, thymol, carvacrol, aromatic sulphur compounds, such as thiophenol, diphenyl disulphide, aromatic nitrogen compounds, such as methyl anthranilate, methyl N-methyl anthranilate, aromatic ethers such as vanillin, ethylvanillin, anethol, aromatic oxides, such as heliotropine, diphenyl oxide, aromatic lactones, such as coumarin, dihydro coumarin, heterocyclic compounds, such as heterocyclic lactones, e.g. gamma butyrolactone, gamma-nonalactone, gamma decalactone, delta decalactone, jasmin lactone, delta dodecalactone, ambrettolide, heterocyclic furanes, such as furfuryl alcohol, furfural, 2-acetyl furan, theaspirane, 2-methyl tetrahydro furan-3-one, furfuryl mercaptane, 2-methyl 3-furanthiol, 2-methyl 3-tetrahydro furanthiol, difurfuryl sulfide, difurfuryl disulfide, heterocyclic pyrans, such as maltol, ethyl maltole, rose oxide, maltol isobutyrate, heterocyclic pyrroles such as indole, 2-acetyle pyrrole, pyrrolidine, heterocyclic pyrazines, such as 2-methyl pyrazine, 2,3-dimethyl pyrazine, 2-methyl 3-ethyl pyrazine, trimethyl pyrazine, 2-acetyl pyrazine, 2-methoxy 3-methyl pyrazine, 2-methoxy 3-ethyl pyrazine, 2-methoxy 3-isobutyl pyrazine, 2-ethyl 3-methylthio pyrazine, heterocyclic thiazoles, such as thiazole, 2-methyl thiazole, 4-methyl 5-vinyl thiazole, 2-isobutyl thiazole, 2-acetyl thiazole,
flavouring raw materials and flavouring preparations, e.g. essential oils, concretes, absolutes, extract or tinctures from raw materials such as citrus (e.g. lemon, lime, mandarine, bergamotte, grapefruit bitter orange, peel or essence oils), herbs (dill, parsley, cumin, rosemary, sage, clary sage, basil, tarragon, thyme, oregano, savoury, majoram, all spice, mace, nutmeg, clove leave, clove bud, caraway, cinnamon leaves, cinnamon bark, cassia, cardamom, ginger, galangal, turmeric, coriander seed, coriander leaf, fenugreek, juniper berry, wormwood, laurel leaves, eucalyptus, white pepper, green pepper, white pepper, carrot seed, celery seed, lovage leaf, asa foetida, onion, leek, garlic, mustard, horse radish, capsicum, paprika, sea weed, valerian oil, fir needle, spearmint, peppermint, wintergreen, buchu leaf, black currant buds, fennel, star anise, jambu, long pepper, davana, orris, mimosa, cassie, violet leaves, ho leaf, jasmin, ylang ylang, cananga, osmanthus, angelica, clary sage, ambrette seed, hops, camomile, lavender, rose, geranium, citronella, palmarosa, litsea cubeba, lemon grass, tagetes, neroli, petitgrain, mate, cognac oil, coffee, cola nut, cocoa, green tea, black tea, white tea, gentian, tolu balm, benzoe resin, peru balm, cascarilla, galbanum, vetiver, labdanum, patchouli, sandalwood, cedarwood, guaiac wood, oak wood, massoi bark, vanilla pods, tonka bean, as well as enriched fractions thereof,
juice concentrates, such as orange juice, lemon juice, strawberry, cherry juice, or passion fruit juice concentrates, waterphases and recoveries from raw materials such as citrus (lemon, lime, orange, mandarine, grapefruit), apple, pear, quince, mispel, red fruits (raspberry, strawberry, blueberry, blackberry, Amellanchia (June plum), rose hip, cranberry, plum, prune, red and black currant, etc.) yellow fruits (peach, apricot, nectarine, banana, etc.), tropical fruits (mango, passionfruit, pineapple, lychee, etc.), vegetables (e.g. cucumber, tomato) and spices (e.g. ginger),
acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineol, cinnamyl acetate, citral, citronellol, citronellal, citronellyl acetate, cyclohexyl acetate, cymene, damascone, decalactone, dihydrocoumarin, dimethyl anthranilate, dodecalactone, ethoxyethyl acetate, ethylbutyric acid, ethyl butyrate, ethyl caprate, ethyl caproate, ethyl crotonate, ethylfuraneol, ethylguaiacol, ethylisobutyrate, ethylisovalerate, ethyl lactate, ethylmethyl butyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzyl acetone, isoamyl alcohol, isoamyl isovalerate, isobutyl butyrate, isobutyraldehyde, isoeugenol methyl ether, isopropyl methylthiazole, lauric acid, levulinic acid, linalool, linalool oxide, linalyl acetate, menthol, menthofuran, methyl anthranilate, methylbutanol, methylbutyric acid, 2-methylbutyl acetate, methyl caproate, methyl cinnamate, 5-methylfurfural, 3,2,2-methylcyclopentenolone, 6,5,2-methylheptenone, methyl dihydrojasmonate, methyl jasmonate, 2-methylmethyl butyrate, 2-methyl-2-pentenol acid, methylthiobutyrate, 3,1-methylthiohexanol, 3-methylthiohexyl acetate, nerol, nerol acetate, trans, trans-2,4-nonadienal, 2,4-nonadienol, 2,6-nonadienol, 2,4-nonadienol, nootkatone, delta-octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulfurol, terpinene, terpineol, terpinolene, 8,3-s thiomenthanone, 4,4,2-thiomethylpentanone, thymol, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3(2H)-furanone and derivatives thereof (here preferably homofuraneol (=2-ethyl-4-hydroxy-5-methyl-3(2H)-furanone), homofuronol (=2-ethyl-5-methyl-4-hydroxy-3(2H)-furanone and 5-ethyl-2-methyl-4-hydroxy-3(2H)-furanone), maltol and maltol derivatives (here preferably ethyl maltol), coumarin and coumarin derivatives, gamma-lactones (here preferably gamma-undecalactone, gamma-nonalactone, gamma-decalactone), delta-lactones (here preferably 4-methyldeltadecalactone, massoilactone, deltadecalactone, tuberolactone), methyl sorbate, divanillin, 4-hydroxy-2(or 5)-ethyl-5 (or 2)-methyl-3 (2H) furanone, 2-hydroxy-3-methyl-2-cyclopentenone, 3-hydroxy-4,5-dimethyl-2(5H)-furanone, acetic acid isoamyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenylglycidate, ethyl-2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio)furan, 2-methyl-3-furanthiol, bis(2-methyl-3-furyl)disulphide, furfurylmer-captan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3 (2H)-furanone, guaiacol, 3-hydroxy-4,5-dimethyl-2(5H)-furanone, 3-hydroxy-4-methyl-5-ethyl-2(5H)-furanone, cinnamaldehyde, cinnamon alcohol, methyl salicylate, isopulegol and (here not explicitly stated) stereoisomers, enantiomers, positional isomers, diastereomers, cis/trans isomers or epimers of these substances.

Preferably, the flavouring mixture according to the invention comprises phyllodulcin in an amount of from 75 to 95 wt.-% preferably 76 to 90 wt.-%, preferably 77.5 to 85 wt.-%, based on the total weight of the dry matter content of the flavouring mixture.

Additionally or alternatively, the flavouring mixture according to the invention comprises hydrangenol in an amount of from 15 to 25 wt.-%, preferably less than 20 wt.-%, preferably less than 15 wt.-%, particularly preferably less than 10 wt.-%, especially preferably less than 5 wt.-% hydrangenol, each based on the total weight of the dry matter content of the extract.

Preferably, the flavouring mixture according to the invention comprises hydrangenol in an amount of from 0.1 to 7.5 wt.-%, preferably in an amount of from 0.5 to 6 wt.-%, preferably in an amount of from 1 to 5 wt.-%, based on the total weight of the dry matter content of the flavouring mixture.

It is preferred that in the flavouring mixture according to the invention the weight ratio of phyllodulcin and hydrangenol is at least 3:1, preferably at least 5:1, particularly preferably at least 7:1, further preferably at least 10:1, more preferably at least 15:1, most preferably at least 25:1, even further preferably at least 30:1, preferably at least 35:1, preferably at least 40:1, preferably at least 45:1, preferably at least 50:1, preferably at least 55:1, preferably at least 60:1, preferably at least 65:1, preferably at least 70:1.

The invention further relates to a composition, preferably a composition serving for food or pleasure or a pharmaceutical composition, comprising a plant extract according to the invention or a flavouring mixture according to the invention.

Preferably, the composition according to the invention may be present in a form selected from the group consisting of tables (non-coated as well as coated tablets, single or multiple layered tablets), capsules, lozenges, granules, pellets, solid substance mixtures, dispersions in liquid phases, emulsions, powders, solutions, juices, pastes or other swallowable or chewable preparations.

It is further preferred that the pharmaceutical composition according to the invention can be present in form of tables (non-coated as well as coated tablets, single or multiple layered tablets), capsules, lozenges, granules, pellets, solid substance mixtures, dispersions in liquid phases, emulsions, powders, solutions, juices, pastes or other swallowable or chewable preparations.

Preferably, the composition according to the invention comprises at least 1 wt.-%, preferably at least 3 wt.-% particularly preferably at least 5 wt.-%, especially preferably at least 10 wt.-% phyllodulcin, based on the total weight of the flavouring mixture and/or preferably wherein the flavouring mixture comprises less than 5 wt.-%, preferably less than 1 wt.-%, particularly preferably less than 0.5 wt.-%, especially preferably less than 0.1 wt.-% hydrangenol, based on the total weight of the composition.

Additionally or alternatively, the composition according to the invention comprises less than 20 wt.-%, preferably less than 15 wt.-%, particularly preferably less than 10 wt.-%, especially preferably less than 5 wt.-% hydrangenol, based on the total weight of the dry matter content of the extract.

Additionally or alternatively, the composition according to the invention comprises hydrangenol in an amount of from 0.1 to 7.5 wt.-%, preferably in an amount of from 0.5 to 6 wt.-%, preferably in an amount of from 1 to 5 wt.-%, based on the total weight of the dry matter content of the composition.

It is preferred that in the composition according to the invention the weight ratio of phyllodulcin and hydrangenol is at least 3:1, preferably at least 5:1, particularly preferably at least 7:1, further preferably at least 10:1, more preferably at least 15:1, most preferably at least 25:1, even further preferably at least 30:1, preferably at least 35:1, preferably at least 40:1, preferably at least 45:1, preferably at least 50:1, preferably at least 55:1, preferably at least 60:1, preferably at least 65:1, preferably at least 70:1.

Preferably, a composition serving for food or pleasure, as described herein, may be selected from the group consisting of (reduced-calorie) baked goods (e.g. bread, dry biscuits, cakes, other baked articles), confectionery (e.g. muesli bar products, chocolates, chocolate bars, other products in bar form, fruit gums, dragees, hard and soft caramels, chewing gum), non-alcoholic drinks (e.g. cocoa, coffee, green tea, black tea, (green, black) tea drinks enriched with (green, black) tea extracts, rooibos tea, other herbal teas, fruit-containing soft drinks, isotonic drinks, refreshing drinks, nectars, fruit and vegetable juices, fruit or vegetable juice preparations), instant drinks (e.g. instant cocoa drinks, instant tea drinks, instant coffee drinks), meat products (e.g. ham, fresh sausage or raw sausage preparations, spiced or marinated fresh or salt meat products), eggs or egg products (dried egg, egg white, egg yolk), cereal products (e.g. breakfast cereals, muesli bars, precooked ready-to-eat rice products), dairy products (e.g. full-fat or reduced-fat or fat-free milk drinks, rice pudding, yoghurt, kefir, cream cheese, soft cheese, hard cheese, dried milk powder, whey, butter, buttermilk, ice-cream, partially or completely hydrolysed milk-protein-containing products), products made from soy protein or other soybean fractions (e.g. soy milk and products produced therefrom, drinks containing isolated or enzymatically treated soy protein, drinks containing soy flour, preparations containing soy lecithin, fermented products such as tofu or tempeh or products produced therefrom and mixtures with fruit preparations and optionally flavours), dairy-like preparations (milk-type, yoghurt-type, dessert-type, ice cream) from protein rich plant materials (e.g. from seed materials of oat, almond, pea, lupine, lentils, faba beans, chickpea, rice, canola), plant protein-enriched non-dairy drinks, fruit preparations (e.g. jams, sorbets, fruit sauces, fruit fillings), vegetable preparations (e.g. ketchup, sauces, dried vegetables, frozen vegetables, precooked vegetables, boiled-down vegetables), snacks (e.g. baked or fried potato crisps or potato dough products, maize- or groundnut-based extrudates), fat- and oil-based products or emulsions thereof (e.g. mayonnaise, remoulade, dressings, in each case full-fat or reduced-fat), other ready-made dishes and soups (e.g. dried soups, instant soups, precooked soups), spices, spice mixtures and in particular seasonings which are used, for example, in the snacks field, sweetener preparations, tablets or sachets, other preparations for sweetening or whitening drinks.

Preferably, the composition according to the invention may be selected from the group consisting of toothpastes, toothpastes, tooth gels, mouthwashes, mouth rinses, liquids for gargling, oral or pharyngeal sprays (pump or aerosol spray), lozenges, lozenges, candies, chewing gums, chewy candies and dental care chewing gums.

Furthermore, the invention also relates to the use of a plant extract according to the invention or of a flavouring mixture according to the invention for imparting or modifying a sweet taste impression.

As e.g. described by the below examples, the plant extract according to the invention or, respectively, the flavouring mixture according to the invention has particularly advantageous sensory characteristics.

Moreover, the invention also relates to a method for imparting or modifying a sweet taste impression, comprising the following steps:
(i) Providing a plant extract according to the invention, preferably by a method according to the invention, or a flavouring mixture according to the invention,
(ii) mixing the plant extract or flavouring mixture obtained in step (i) with a substance or product, of which a sweet taste impression shall be imparted or modified.

The term “modifying a sweet taste impression” as used herein describes any kind of modification, such as optimizing or increasing a sweet taste impression.

Further aspects and advantages of the invention result from the subsequent description of preferred examples.

### EXAMPLES

### Example 1: Method for Producing a Plant Extract Comprising Phyllodulcin

100 g of rubbed, dried leaves of Hydrangea macrophylla were placed in an extractor together with 1000 g water, having a temperature of 40° C. A fermentation was performed for 2 hours at 40° C. of the moistened leaf material. Subsequently, the supernatant water was discharged and ethanol—in the amount of the discharged water—was added to the moist extraction material. A first extraction was performed by stirring and at 40° C. for 2 hours at normal pressure (i.e. 1013 mbar). The first extract was collected and a second extraction was performed by adding further 500 g ethanol to the extraction material and under stirring for 2 hours and at 40° C. The extraction material was pressed to collect the second extract. Both extracts were combined and filtered with a 5 μm bag filter. The amount of extract was subsequently reduced to 700 g by distillation. The amount of phyllodulcin was in a range of from 0.2 to 0.4 wt.-% in the obtained extract.

Subsequently, the extract was diluted with 4300 g water and a purification of the extract was performed via solid phase adsorption. The column material (a column of 25 mm×250 mm column dimension and filled with 60 g cross-linked polystyrene was used) was activated with 380 g ethanol and a flow of 25 ml/min. The ethanol was driven out with 1200 g water and the diluted extract was applied at a flow of 15 ml/min. Subsequently, the column was washed with 900 g water at a flow of 25 ml/min, dried with nitrogen and eluted with 250 g ethanol in the flow direction of the adsorption (flow: 15 ml/min). During the elution, a cloudy, brown flow was discharged.

The obtained ethanol eluate (230 g) was heated to 60° C. in a distillation apparatus and the ethanol was separated, with a residual amount of 25 g of ethanol in the eluate. Subsequently, the hot mixture was filtered and cooled down to room temperature and then to 5° C. while stirring and was stored at 5° C. for 24 h. The precipitated raw product was separated and washed at 5° C. twice with each 20 g of pre-cooled ethanol for 30 min. The washed solid was separated from the washing solution and dried at 25° C. Approximately 1.7 g of dried product was obtained. The concentration of phyllodulcin was 85 wt.-%.

### Example 2: Method for Producing a Plant Extract Comprising Phyllodulcin

100 kg of rubbed, dried leaves of Hydrangea macrophylla were fermented with 800 kg water in an extractor for 2 hours at a temperature of 40° C. Subsequently, the supernatant water was discharged and the plant material was pressed. 470 kg ethyl acetate were added to the moist extraction mixture. A first extraction was performed by stirring and at 40° C. for 2 hours at normal pressure (i.e. 1013 mbar). The first extract was collected and a second extraction was performed by adding further 400 kg ethyl acetate to the extraction material and under stirring for 2 hours and at 40° C. The second extract was separated and combined with the first extract. The combined extract was filtered with a 5 μm bag filter. The ethyl acetate phase was concentrated to approximately 130 kg.

After addition of 100 kg ethanol to the ethyl acetate containing extract, the remaining ethyl acetate was removed by distillation. Approximately 130 kg of solvent were removed by distillation and approximately 100 kg extract were obtained. The phyllodulcin concentration of the extract was approximately 3 wt.-%.

The mixture was heated to 60° C. to prevent a precipitation of the raw product and to separate ethanol by distillation for a further concentration of the raw product. Approximately 20 kg of extract with approximately 12 wt.-% phyllodulcin were obtained. Subsequently, the hot mixture was filtered and cooled down to room temperature and then to 5° C. in a tub while slightly stirring. The cooled mixture was stored at 5° C. for 18 hours.

The precipitated raw product was separated and washed at 5° C. twice with each 5 kg of pre-cooled ethanol for 30 min. The washed solid was separated from the washing solution and dried at 25° C. Approximately 3 kg of moist product or, respectively, approximately 2 kg of dried product was obtained. The concentration of phyllodulcin was 88 wt.-%.

### Example 3: Comparison of Sensory Characteristics and Stability

The following mixtures were prepared:
M1: According to example 1, wherein the leaf material was extracted with ethanol (in an amount of 8 times of the weight of the leaf material); a solid phase purification and precipitation was performed, the solid was washed with ethanol (in an amount of 5 times of the weight of the solid) at 5° C.
C1: According to example 1, wherein the leaf material was extracted with ethanol (in an amount of 12 times of the weight of the leaf material) and a solid phase purification was performed. However, no precipitation and no washing step was performed.
C2: According to example 1, wherein the leaf material was extracted with ethyl acetate (in an amount of 12 times of the weight of the leaf material) and a solid phase purification was performed. However, no precipitation and no washing step was performed.
C3: According to example 2, wherein the leaf material was extracted with ethyl acetate (in an amount of 14 times of the weight of the leaf material) and wherein the precipitation was performed with ethanol at 5° C. However, no washing step was performed.
M2: According to example 2, wherein the leaf material was extracted with ethyl acetate (in an amount of 7 times of the weight of the leaf material) and wherein the precipitation was performed with ethanol at 5° C. Furthermore, the solid was washed with ethanol (in an amount of 3 times of the weight of the solid) at 5° C.
M3: According to example 2, wherein the leaf material was extracted with ethyl acetate (in an amount of 7 times of the weight of the leaf material) and wherein the precipitation was performed with ethanol at 5° C. Furthermore, the solid was washed with ethanol (in an amount of 3 times of the weight of the solid) at 5° C.

For the sensory evaluation of M1 to M3 (according to the invention) and C1 to C2 (controls), the samples were evaluated by a trained test panel. For M1 to M3 and for C3, a concentration of 6 mg sample per 1 kg water were evaluated. For C1, the concentration was 11 mg per 1 kg water. For C2, the concentration was 9 mg per 1 kg water.

For testing the stability, the samples were provided in a 3% ethanolic solution and stored for one month at 40° C.

| | Composition | | |
|---|---|---|---|
| Sample | [wt.-%] | Sensory evaluation | Stability |
| M1 | P: 78.8 | No considerable off- | No turbidity, no |
| | H: 8.56 | notes, sweet | discoloration, no |
| | | modulation | precipitation |
| C1 | P: 48.4 | Herbaceous, algae, | Fine and slightly |
| | H: 8.03 | fishy | green precipitation |
| C2 | P: 60.7 | Herbaceous, algae, | Fine and slightly |
| | H: 13.5 | fishy | green precipitation |
| C3 | P: 87.7 | Herbaceous notes | White coloured |
| | H: 0.65 | were perceived | streaks |
| M2 | P: 91.4 | No considerable off- | No turbidity, no |
| | H: 0.44 | notes, sweet | discoloration, no |
| | | modulation | precipitation |
| M3 | P: 88.9 | No considerable off- | No turbidity, no |
| | H: 0.46 | notes, sweet | discoloration, no |
| | | modulation | precipitation |

PD: phyllodulcin;
H: hydrangenol

The above experiments show that only a method according to the invention provides extracts containing phyllodulcin, which have an advantageous sensory profile and are stable when being stored, since no considerable off-notes, no turbidity, no discoloration and no precipitation was observed in the extracts according to the invention.

As can be also seen by the above experiments, it is not simply the amount of phyllodulcin and/or hydrangenol, which influences the sensory profile, but also the underlying method of producing the extract (cf. C3 against M1 to M3).

### Example 4: Sensory Evaluation of Different Amounts of Phyllodulcin

Two samples (samples 1 and 2) were prepared by a method according to the invention. Particularly, the leaf material was extracted two times with ethyl acetate (in an amount of 5 times of the weight of the leaf material) and wherein the precipitation was performed with ethanol at 10° C. Furthermore, the solid was washed with ethanol (in an amount of 3 times of the weight of the solid) at 5° C.

Sample 3 was extracted from leaf material, however, no precipitation was performed.

The samples were then compared with the pure substance (R)-phyllodulcin with regard to their sensory evaluation.

| | Composition | Dose | Panel | Sweetness | |
|---|---|---|---|---|---|
| Sample | [wt.-%] | [mg/kg] | [n] | [%] | p-value |
| (R)-phyllodulcin | | 5 | 20 | 27.0 | 0.020 |
| 1 | P: 91.9 | 6 | 20 | 25.4 | 0.030 |
| | H: 0.26 | | | | |
| 2 | P: 81.9 | 6 | 20 | 32.6 | 0.005 |
| | H: 18.1 | | | | |
| 3 | P: 47.9 | 11 | 19 | 31.6 | 0.011 |
| | H: 43.2 | | | | |

P: phyllodulcin;
H: hydrangenol

As shown in the above table, all samples (all according to the invention) provide a similar sweetness as the pure substance (R)-phyllodulcin.

Surprisingly, it was found that sample 2 with an amount of 81.9 wt.-% phyllodulcin provided the same sweetness as the pure substance (R)-phyllodulcin (when calculating the sweetness of 1 mg of the sample). Increasing as well as decreasing the amounts of phyllodulcin (samples 1 and 3) slightly increased the provided sweetness (when calculating the sweetness of 1 mg of the sample).

1-15. (canceled)

16. A method for producing a plant extract comprising phyllodulcin comprising:
(i) drying plant material comprising phyllodulcin;
(ii) moistening the dried plant material of (i) with water and wet fermenting the moistened plant material at 10 to 50° C.;
(iii) subjecting the wet fermented plant material of (ii) to extraction with a solvent at a temperature of 0° C. to boiling point of the solvent;
(iv) collecting supernatant (S1) from the extraction of (iii) and optionally repeating (iii) and collecting supernatant (S2) and combining S1 and S2;
(v) replacing solvent in the supernatant with ethanol to obtain a mixture, wherein the replacement of solvent is optional when ethanol or a mixture comprising ethanol is used as the solvent in (iii) and/or (iv);
(vi) heating the mixture of (v) or supernatant of (iv) when (v) is omitted, to 40 to 79° C. to reduce the amount of ethanol;
(vii) cooling the mixture of (vi) to a temperature of 10° C. or less after the heating of (vi) to precipitate extracted compounds;
(viii) washing the cooled mixture of (vii) with a washing agent having a temperature of 10° C. or less,
wherein the washing agent and the cooled mixture of (vii) are in a weight ratio of at least 1:1; and
(ix) drying the precipitated extracted compounds to obtain the plant extract comprising phyllodulcin.

17. The method of claim 16, wherein the plant material is plant leaves.

18. The method of claim 16, wherein the plant material is from Hydrangea macrophylla.

19. The method of claim 18, wherein the Hydrangea macrophylla is Hydrangea macrophylla ssp. serrata.

20. The method of claim 16 wherein the solvent of (iii) is selected from water, supercritical CO₂, methanol, methyl acetate, ethanol, ethyl acetate, n-heptane, n-hexane, deep eutectic solvents, and mixtures thereof.

21. The method of claim 16, wherein after (iii) or (iv) the extract is purified by solid-phase adsorption.

22. The method of claim 21, wherein the solid-phase adsorption uses an adsorbent selected from polystyrene, aliphatic methyl acrylate, or a mixtures thereof.

23. The method of claim 22, wherein the adsorbent is crosslinked polystyrene or a mixture of crosslinked polystyrene and aliphatic methyl acrylate.

24. The method of claim 16, wherein the wet fermentation of (iii) is performed for 0.5 to 10 hours.

25. The method of claim 16, wherein the replacement in (v) is achieved by distillation or a method comprising distillation.

26. The method of claim 16, wherein the mixture is filtered after (vi).

27. The method of claim 16, wherein the plant material comprises at least 2.5 wt. % of phyllodulcin equivalents, based on a total weight of the plant material.

28. The method of claim 16, wherein the plant material comprises 2 wt. % or less pf hydrangenol equivalents, based on a total weight of the plant material.

29. A plant extract obtainable by the method of claim 16, wherein the plant extract comprises at least 50 wt. % of phyllodulcin and less than 20 wt. % of hydrangenol, based on a total dry weight of the plant extract.

30. The plant extract of claim 29, wherein the plant extract comprises 75 to 95 wt. % of phyllodulcin, based on the total dry weight of the plant extract.

31. A composition comprising the plant extract of claim 16.

32. The composition of claim 31, wherein the composition is a flavoring composition comprising least 50 wt. % of phyllodulcin and less than 20 wt. % of hydrangenol, based on a total weight of the composition.

33. A method for imparting a sweet taste impression to a substance or modifying a sweet taste impression of the substance comprising adding the plant extract of claim 29 to the substance.
